(19) United States
(12) Patent Application Publication
(10) Pub. No.: US 2013/0218447 A1
(43) Pub. Date: Aug. 22, 2013

(54) METHOD FOR DETERMINING THE RANGE OF A MOTOR VEHICLE

(71) Applicant: Josef Mayinger, Daiting (DE)

(72) Inventor: Josef Mayinger, Daiting (DE)

(73) Assignee: AUDI AG, Ingolstadt (DE)

(21) Appl. No.: 13/879,565

(22) PCT Filed: Jul. 16, 2011
(86) PCT No.: PCT/EP2011/003559

§ 371 Date: Apr. 15, 2013

(30) Foreign Application Priority Data
Oct. 13, 2010 (DE) 10 2010 048 387.7

(51) Int. Cl. G06F 17/00

(52) U.S. Cl. CPC G06F 17/00
USPC 701/123

(57) ABSTRACT

In a method for determining the range of a motor vehicle, the temperature of at least one predetermined component of the motor vehicle and/or another parameter which detects the physical or chemical state of the component, and/or a measured outer temperature or outer temperature known from wirelessly transmitted weather data or other environmental parameter at the location of the motor vehicle and/or on a planned driving course are taken into account, and the amount of energy to be consumed in dependence of the at least one parameter, by at least one power consumer for establishing and/or maintaining the operability of the motor vehicle is taken into account for determining the range.

The invention relates to a method for determining the range of a motor vehicle. In particular in motor vehicles, which include an electric drive, i.e., electric vehicles or so-called hybrid vehicles, the range is of interest because especially electric vehicles at least at this time only have a relatively short range; in addition, in motor vehicles with electric drive, electric energy has to be provided typically in the form of electrochemical energy storage devices (batteries), which cannot be recharged as quickly as a fuel tank can be refilled. However, the present invention can also be used when the motor vehicle only includes an internal combustion engine.

A method for determining the range of an electric vehicle is known from DE 103 02 504 A1. Here, items of information relating to the vehicle, driving distances, and/or items of information about the vehicle in relation to its environment, and a course to be driven on or actually being driven on are detected by a vehicle computer by means of appropriate information detection devices and analyzed. The, analysis includes an assessment of changing operational modes of the vehicle. This printed publication also mentions taking into account whether the vehicle driver wishes to use certain vehicle comfort functions such as for example air-conditioning. In the case that the comfort functions would excessively deplete the reserve of the electric energy, the driver is provided with corresponding information by the vehicle computer. The goal is that the driver can limit his comfort requests to what is necessary to reach the destination.

DE 100 29 886 C1 also describes determining the range of a motor vehicle which involves determining a rise in temperature in the motor vehicle by an energy management system. Apparently, the air temperature is measured. The measurement already occurs when the motor vehicle stands still and the driver is informed of the temperature in the interior of the motor vehicle via a radio link and can turn on the air-conditioning by means of a command. It is then verified whether in case the air-conditioning is active, a desired destination which is entered as a destination of the navigation system can still be reached.

In particular a motor vehicle with electric drive is not necessarily guaranteed to be readily operational: it cannot always immediately be started and maintained in operation. Additional impediments are involved here compared to those known from conventional motor vehicles. To obviate the impediments, energy has to be retrieved from the energy storage device and is then no longer available for the actual movement. Furthermore—like in conventional motor vehicles—additional energy has to be expended for certain processes/necessary procedures which also restricts a possible range.

It is an object of the invention to take these impediments and procedures into account for determining the range.

The object is solved by a method with the features of patent claim 1.

In the method according to the invention, the measured environmental conditions, preferably however, climate data obtained via weather data in the region of the course to be driven on and/or at least the temperature of at least one predetermined component of the motor vehicle are taken into account. Then, the amount of energy to be consumed by at least one power consumer that is required for establishing and/or maintaining the operability of the motor vehicle, and depends on the at least one detected temperature is taken into account for determining the range. In the same way, another parameter can be measured which detects the physical or chemical condition of at least one component, (for example the charge state of the battery) if this parameter allows determining the amount of energy to be expended for establishing and maintaining operability.

The invention is based on the recognition that impediments which would prevent initiating or maintaining operation of the motor vehicle occur at defined temperatures and do not, or only to a smaller degree, occur at other temperatures, or on the recognition that such impediments can be recognized by way of physical measurement values or other parameters and/or weather data.

This applies for example, when the at least one power consumer also includes a device for changing the temperature of an electrochemical energy storage device (the battery) for operating the electric drive. In this case, the invention is based on the recognition that most batteries for electric drives have to have a predetermined temperature in order to provide a sufficient amount of energy for the electric drive. Therefore, before initiating operation of the motor vehicle, they have to be preheated in case of low temperature and have to be cooled down in case of high temperature and also have to be cooled during operation. The energy required in this case is taken into account within the framework of the invention when determining the range, for determining the range as accurately as possible; because the above-mentioned energy expenditure at least at some temperatures is significant.

In this embodiment, the predetermined component of the motor vehicle is preferably the battery itself.

Further, reduction of the range applies in a case when the at least one power consumer includes a device for clearing the window of condensation (with moisture and so on) or of a covering (with ice); because an icing over of the window only occurs for example below a certain temperature threshold. Optionally, the humidity can also be taken into account. The device can for example include a hot air fan, simply be heating by means of a heating wire, or can include windows which are coated with metal vapor and are heated.

Preferably, the invention is used in a motor vehicle as mentioned previously which includes an electric drive.

In the case of more extreme environmental temperatures, whether cold or hot—especially in the case of increased humidity and sun exposure and/or pollution of the ambient air—it may be necessary to expend additional energy to climatically treat the air in the vehicle and/or purify the air from pollutants, i.e. far in excess of a pure comfort requirement, for example when driving through smog zones or when transporting temperature-sensitive items and animals. In the case of fog, unfavorable light conditions or due to legal provisions, driving with the lights turned on is required. These additional energy expenditures can also factor into a calculation of the range. In this case, corresponding measurement data relating to the outside temperature or relating to physical or chemical parameters which are defined with regard to the environment (for example humidity, ozone content) are required. Such data can be transmitted wirelessly from a weather service to the motor vehicle, in particular also across places on a (planned) course to be driven.

In a preferred embodiment, the energy to be expended for moving the motor vehicle is estimated as a function of the corresponding temperature value because the temperature value is measured anyway and/or is available via weather data from the course to be driven on; because for example the rolling resistance, the inner friction resistance (for example in the drivetrain) and the air resistance of a motor vehicle depend on the temperature. In this case, the respective component whose temperature is measured can be the predetermined component itself. Especially at lower temperatures, higher energy consumption is to be taken into account for overcoming the aforementioned resistances.

Preferably, in an alternative, the method according to the invention is performed prior to starting the drive. Determining the range in this case serves for informing the driver whether an intended drive—with desired reserves—can be performed. Typically, the range is determined by (or in) the motor vehicle itself and is then transmitted wirelessly to a vehicle-external device (for example a smartphone or mobile wireless phone) carried by the driver or to an information center. As an alternative or in addition, the energy consumption is continuously determined during the drive to a predetermined destination, compared with the level of the energy storage device, the range calculation continuously updated and the driver or other vehicle occupants informed whether the predetermined destination can be reached with or without a predetermined measure, wherein in particular in an electric vehicle or in a motor vehicle with hybrid drive, the predetermined measure can involve recharging a battery of the motor.

In the following, the invention is explained in more detail by way of an exemplary embodiment.

For determining the range of a motor vehicle, techniques from the state of the art can be used. For example, a desired destination can be entered into a navigation system of the motor vehicle, and a navigation system can then determine the suggested course. For the suggested course, the change in altitude, the rolling resistance of the road and other components are known, for example obstacles such as traffic lights and railway crossings. For determining the range, it can also be taken into account whether the driver has certain comfort requests, for example whether he desires to activate an air-conditioning or seat heating. When the properties of the motor vehicle are known, the energy consumption can be estimated by way of an energy balance.

The invention provides for taking the following into account regarding the overall energy balance: it may be that the motor vehicle is not readily operational. For example when the motor vehicle is an electric vehicle it may be that due to a too low temperature, a battery of the motor vehicle first has to be preheated, or that the battery in case of high temperatures has to be cooled initially or during the entire drive. Also, in conventional vehicles with internal combustion engine, additional energy has to be used for heating up the engine—and for overcoming the higher vehicle specific resistances—, in the case of a hot engine, additional energy may be required for cooling.

It is also possible that the windshield and the other windows of a motor vehicle are iced over or misty and have to be heated up, at least at the beginning of the drive and possibly during the entire drive. It may be necessary that energy for air purification and temperature conditioning systems is required for the interior of the vehicle. All this can be calculated in that the environmental conditions (such as for example temperature, humidity, sun exposure or pollution of the ambient air) are detected via generally available weather data and/or are actually measured or via the temperature of a predetermined component of the motor vehicle such as for example the battery, the internal combustion engine, the transmission, the entire drive train or the windshield itself. An intelligent unit inside the motor vehicle (data processing unit) can then calculate based on the measurement values of corresponding sensors and/or the information relating to weather data, in which manner driving resistances have to be taken into account and which power consumers have to be activated for establishing/maintaining the operability of a motor vehicle. The energy that has to be consumed for this is taken into account in the overall energy balance and with this for determining the range by an intelligent unit, preferably inside the motor vehicle. In view of the energy consumption—and with this also the range of a vehicle—a dependency on defined parameters such as for example the temperature exists. This dependency can be determined during development of a new vehicle and can be stored in the form of characteristic diagrams in databases for example in control devices. In this case, this optimized range calculation is already available in the respective serial vehicle on the first day. However, it is also possible that the energy amounts that are required in excess of a normal operation are respectively additionally detected only when operating the vehicle, wherein this normal operation is for example defined by parameters which are determined for the type checking. These data can also be stored for example in control devices and—in case of the same boundary conditions—can again form the basis for an intelligent range calculation.

The invention allows a particularly accurate range calculation. The determined range can already be transmitted long before the start of the drive to mobile telephone of the driver another mobile device, or information central (networked to computer). During the drive corresponding updated range displays more alerts to the driver, to other occupants in the motor vehicle or to an information center can occur.

1.-7. (canceled)

8. A method for determining a range of a motor vehicle, comprising;
determining as a function of a temperature of an electrochemical storage device for operating a drive of the motor vehicle and of an outside temperature at a location of the motor vehicle, an amount of energy required by a device of the motor vehicle for preheating the electrochemical energy storage device for establishing an operability of the motor vehicle, wherein the outside temperature is measured or is obtained from wirelessly transmitted weather data; and
determining the range of the motor vehicle as a function of the amount of energy required by the device for preheating the electrochemical storage device.

9. The method of claim 8, further comprising measuring a temperature of at least one further component of the motor vehicle, wherein the range of the motor vehicle is determined further as a function of the temperature of the at least one further component of the motor vehicle.

10. The method of claim 8, wherein said method is performed at a start of a drive of the motor vehicle, said range being determined in the motor vehicle, said method further comprising wirelessly transmitting the range to a device outside the motor vehicle.

11. The method of claim 8, wherein the range is further determined as a function of a charge state of the electrochemical energy storage device of the motor vehicle.
